(19) United States
(12) Patent Application Publication
(10) Pub. No.: US 2012/0173874 A1
(43) Pub. Date: Jul. 5, 2012

(54) Method And Apparatus For Protecting Against A Rogue Certificate

(75) Inventors: Craig M. Brown, Harbord (AU); Craig W. Northway, Sydney (AU); Jessica M. Purser, Sydney (AU)

(73) Assignee: QUALCOMM Incorporated, San Diego, CA (US)

(21) Appl. No.: 12/984,533

(22) Filed: Jan. 4, 2011

(51) Int. Cl. H04L 29/06

(52) U.S. Cl. 713/157

(57) ABSTRACT

Disclosed is a method for protecting against a rogue certificate. In the method, a web client receives a first certificate from a server during an initial session. The first certificate has a first certificate chain to an authority certificate signed by a certificate authority. The web client receives a second certificate during a subsequent session. The second certificate has a second certificate chain to a signed authority certificate. The web client assigns a signature security rating to each chain certificate in the first and second certificate chains. The web client compares the signature security rating of each corresponding chain certificate in the first and second certificate chains. The web client treats the second certificate as insecure if the signature security rating of a chain certificate in the second certificate chain is lowered from that of a corresponding chain certificate in the first certificate chain.

### BACKGROUND

1. Field

The present invention relates generally to secure browsing of trusted web sites.

2. Background

A web client uses a certificate chain to a trusted certificate authority to identify a trusted web site. Each certificate in the chain may use one of a variety of cryptographic techniques, such as MD5, SHA-1, SHA-2, and the like, to protect the certificate from forgery. The cryptographic techniques have varying levels of integrity. However, a web client treats certificates based on differing cryptographic techniques alike, regardless of the integrity level of the cryptographic technique.

In recent years, it has been shown that MD5 can be faked, allowing a web site to be impersonated. Further, it is conceivable that SHA-1, then SHA-2, may be compromised in the future, which would require replacement by better solutions. Even with replacement, legacy systems may allow for the continued use of a compromised technique, such as is the current case with MD5.

There is therefore a need for a technique for effectively and efficiently protecting against web site impersonation using a rogue certificate.

### SUMMARY

An aspect of the present invention may reside in a method for protecting against a rogue certificate. In the method, a client receives a first certificate from a server during an initial session. The first certificate has a first certificate chain to an authority certificate signed by a certificate authority. The client assigns a signature security rating to each chain certificate in the first certificate chain. The client receives a second certificate during a subsequent session. The second certificate has a second certificate chain to an authority certificate signed by a certificate authority. The client assigns a signature security rating to each chain certificate in the second certificate chain. The client compares the signature security rating of each chain certificate in the first certificate chain with the signature security rating of each corresponding chain certificate in the second certificate chain. The client treats the second certificate as insecure if the signature security rating of a chain certificate in the second certificate chain is lowered from a signature security rating of a corresponding chain certificate in the first certificate chain.

In more detailed aspects of the invention, the client may provide to a user a warning of an impersonation danger for the second certificate associated with a lowered signature security rating. Also, the client may provide the warning in the form of a visual display. The visual display may comprise color coding.

In other more detailed aspects of the invention, the client may be associated with a web browser application, and the server may be associated with a web site. Also, the client may be associated with a mobile application. Further, the client may be a remote sensor. In addition, the client may automatically act on an impersonation danger for the second certificate associated with a lowered signature security rating.

Another aspect of the invention may reside in a station, including: means for receiving a first certificate from a server during an initial session, wherein the first certificate has a first certificate chain to an authority certificate signed by a certificate authority; means for assigning a signature security rating to each chain certificate in the first certificate chain; means for receiving a second certificate during a subsequent session, wherein the second certificate has a second certificate chain to an authority certificate signed by a certificate authority; means for assigning a signature security rating to each chain certificate in the second certificate chain; means for comparing the signature security rating of each chain certificate in the first certificate chain with the signature security rating of each corresponding chain certificate in the second certificate chain; and means for treating the second certificate as insecure if the signature security rating of a chain certificate in the second certificate chain is lowered from a signature security rating of a corresponding chain certificate in the first certificate chain.

Another aspect of the invention may reside in a station comprising a processor configured to: receive a first certificate from a server during an initial session, wherein the first certificate has a first certificate chain to an authority certificate signed by a certificate authority; assign a signature security rating to each chain certificate in the first certificate chain; receive a second certificate during a subsequent session, wherein the second certificate has a second certificate chain to an authority certificate signed by a certificate authority; assign a signature security rating to each chain certificate in the second certificate chain; compare the signature security rating of each chain certificate in the first certificate chain with the signature security rating of each corresponding chain certificate in the second certificate chain; and treat the second certificate as insecure if the signature security rating of a chain certificate in the second certificate chain is lowered from a signature security rating of a corresponding chain certificate in the first certificate chain.

Yet another aspect of the invention may reside in a computer program product comprising computer-readable medium, comprising: code for causing a computer to receive a first certificate from a server during an initial session, wherein the first certificate has a first certificate chain to an authority certificate signed by a certificate authority; code for causing a computer to assign a signature security rating to each chain certificate in the first certificate chain; code for causing a computer to receive a second certificate during a subsequent session, wherein the second certificate has a second certificate chain to an authority certificate signed by a certificate authority; code for causing a computer to assign a signature security rating to each chain certificate in the second certificate chain; code for causing a computer to compare the signature security rating of each certificate in the first certificate chain with the signature security ratings of each corresponding chain certificate in the second certificate chain; and code for causing a computer to treat the second certificate as insecure if the signature security rating of a chain certificate in the second certificate chain is lowered from a signature security rating of a corresponding chain certificate in the first certificate chain.

### BRIEF DESCRIPTION OF THE DRAWINGS

FIG. 1 is a flow diagram of a method for protecting against a rogue certificate, according to an aspect of the present invention.

FIG. 2 is a block diagram of a system for protecting against a rogue certificate, according to an aspect of the present invention.

FIG. 3 is a schematic diagram of first and second certificate chains.

FIG. 4 is a schematic diagram of a browser window having a URL field that may be color coded.

FIG. 5 is a block diagram of an example of a wireless communication system.

FIG. 6 is a block diagram of an example of a mobile station.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

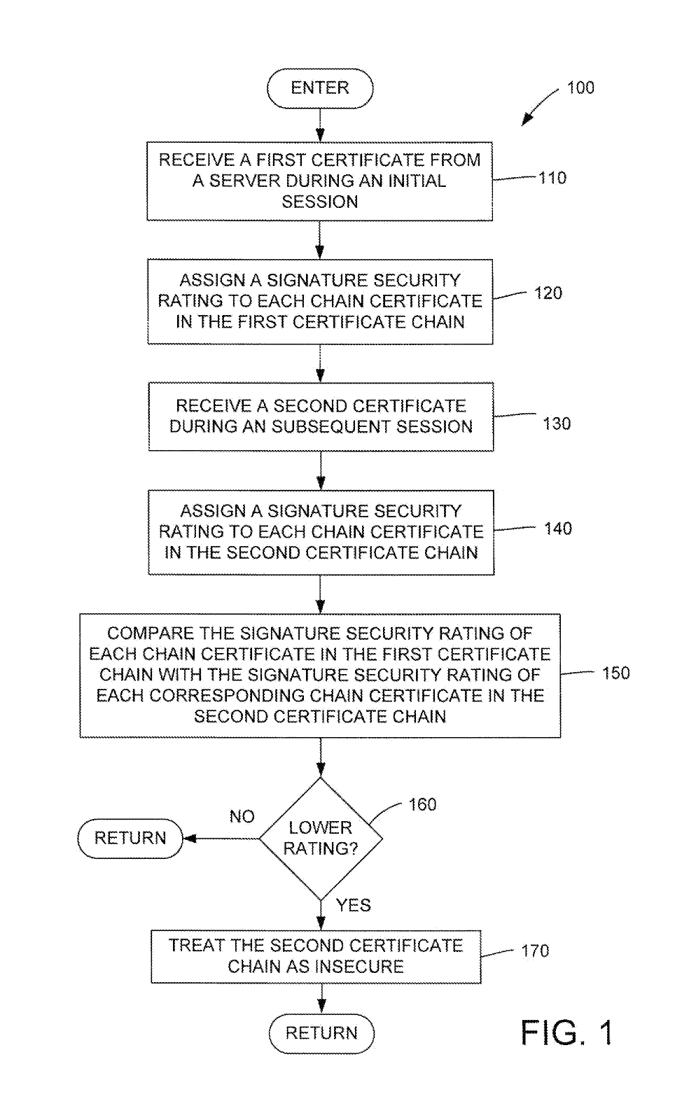

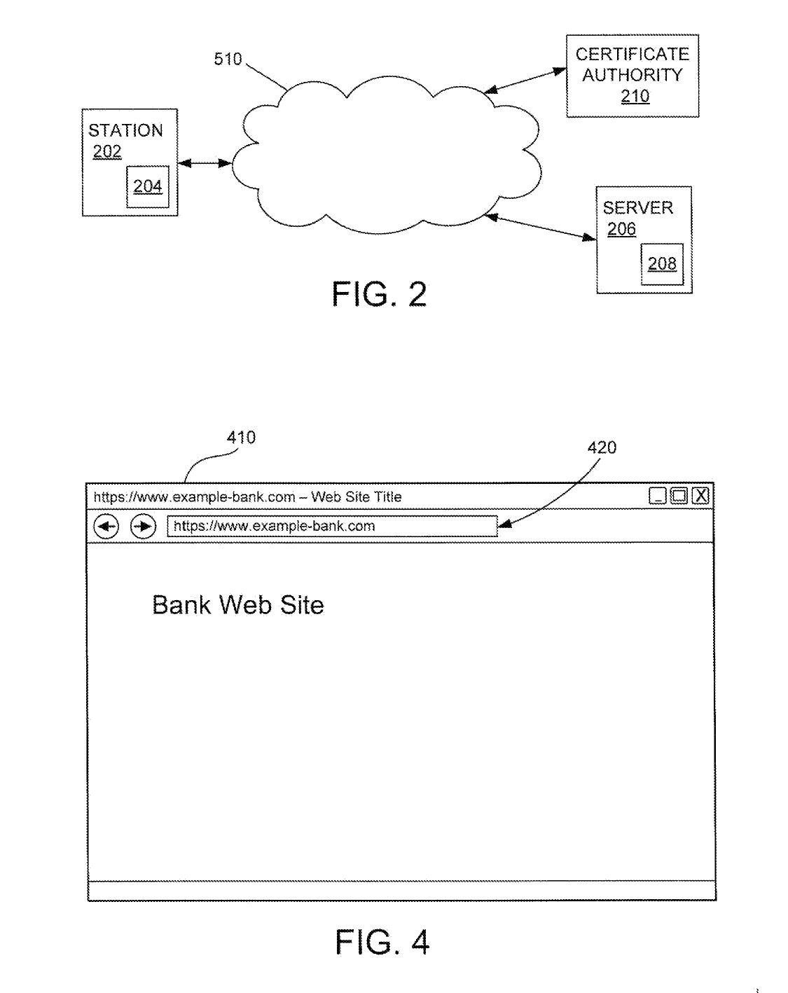

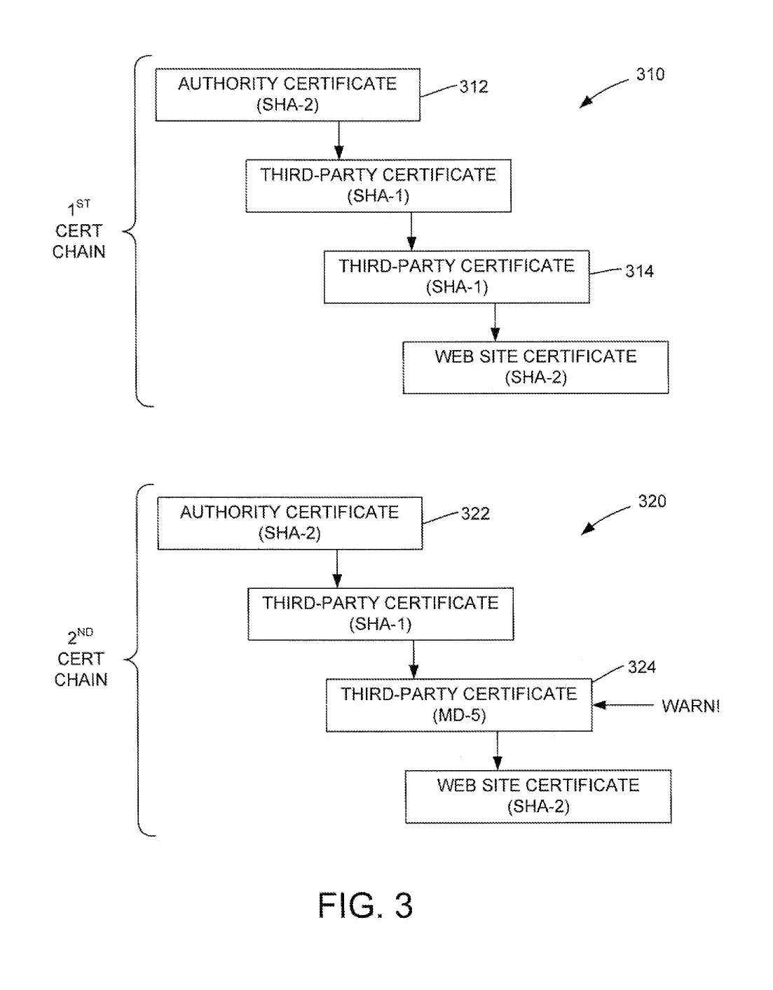

With reference also to FIGS. 1-3, an aspect of the present invention may reside in a method 100 for protecting against a rogue certificate. In the method, a client 204 receives a first certificate 310 from a server 206 during an initial session (step 110). The first certificate has a first certificate chain to an authority certificate 312 signed by a certificate authority 210. The client assigns a signature security rating to each chain certificate in the first certificate chain (step 120). The client receives a second certificate 320 during a subsequent session (step 130). The second certificate has a second certificate chain to an authority certificate 322 signed by a certificate authority. The client assigns a signature security rating to each chain certificate in the second certificate chain (step 140). The client compares the signature security rating of each chain certificate in the first certificate chain with the signature security rating of each corresponding chain certificate in the second certificate chain (step 150). If the signature security rating of a chain certificate 324 in the second certificate chain is lowered from a signature security rating of a corresponding chain certificate 314 in the first certificate chain (step 160), the client treats the second certificate as insecure (step 170).

Treating the second certificate 320 as insecure may include refusing to use the second certificate, providing a warning to the user of an impersonation danger, and/or asking for user confirmation before proceeding.

With reference to FIG. 4, the client 204 may provide the warning in the form of a visual display in the web browser interface 410 presented to the user. The visual display may comprise color coding in, for example, the URL field 420. The color code may be red when the certificate chain has a lowered signature security rating from the last visit to the web site, and may be green for a certificate chain having no change to the signature rating since the last visit to the web site.

The client 204 may be associated with a web browser application, and the server may be associated with a web site 208. Also, the client may be associated with a mobile application. Further, the client may automatically act on an impersonation danger for the second certificate associated with a lowered signature security rating. For example, a remote sensor may automatically stop responding to a server. In addition, the client may be a remote sensor such as a location tracking device that contacts a server 206 to periodically send its current location. Should the device attempt to send its location information to the server and receive a downgraded certification in a second certificate chain, it is likely that the device is not sending to the server it should be sending to. Accordingly, the location tracking device would not send the potentially sensitive location information to the presumably rogue server.

A web site's certificate 310 includes a certificate chain to a trusted certificate authority 210. Each certificate (e.g., 314) in the chain is signed using an encryption technique such as MD5, SHA-1 and SHA-2, to generate a signature. According to an aspect, the present invention provides a level of protection against web site impersonation using fake low-security certificate/key chains by grading chains, and identifying suspect ones. A typical user does not know the difference between MD5, SHA-1 and SHA-2. For example, a secure banking web site 206 may use a relatively secure technique such as using a SHA-2 chain, but the web site could be impersonated by someone with a fake (lower security) MD5 chain. Without the present invention, a typical user will not notice or receive a warning that the security level of the web site's chain has been lowered. Most web clients 204 currently support MD5 because of the many legacy web servers 208 that use MD5. Further, the security issue is not just a problem due to MD5. As computers get faster, and as cryptographers develop more clever techniques, SHA-1, then SHA-2, will likely be compromised, and then replaced by more secure techniques.

If on the first visit, the certificate chain of a web site 206 contains SHA-2-based certificate signatures, and on a subsequent visit, any certificate in the chain degrades to a lower signature security rating, such as a signature based on MD5, it's far more likely this is an impersonation attack rather than an instance of the web site intentionally degrading their certificates. According to one aspect, the web client application warns the user when a lowering of the signature security rating occurs, and treats the web site as an insecure, impersonated web site. Generally, protection is not available during the first visit to a web site, but it is available during subsequent visits.

The web client application may perform different operations depending on the security rating of the hash functions used in the certificate chain. In addition, the web client application may provide a warning where the web site's certificate is more secure than one of the certificates in the middle of the chain.

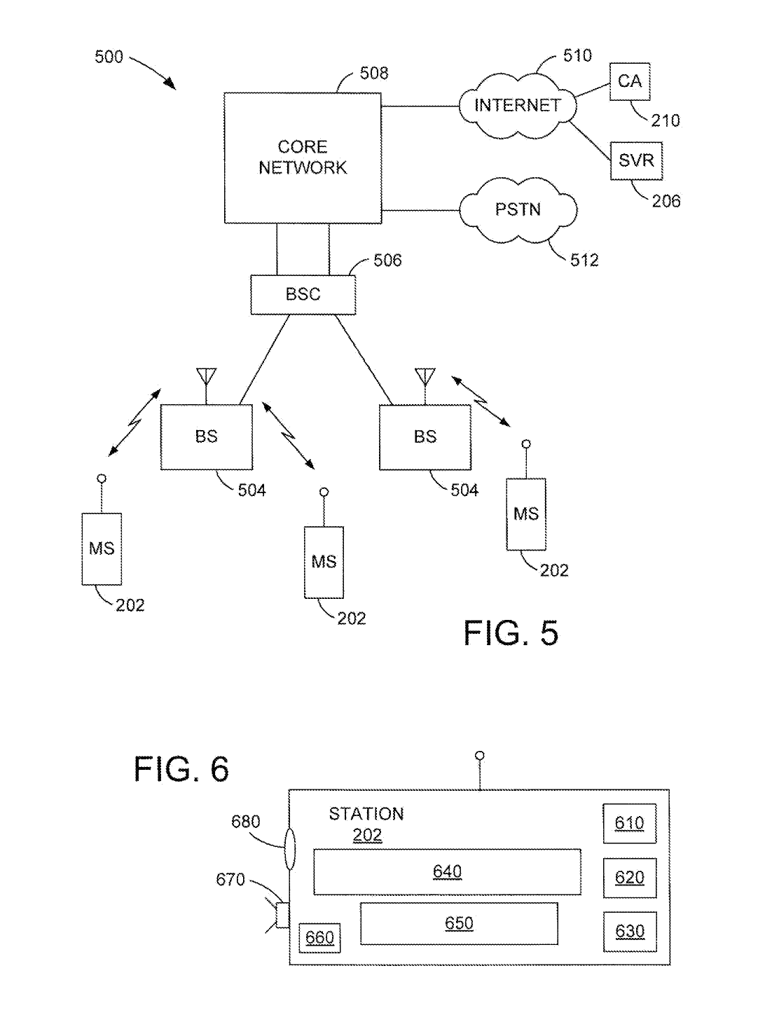

With further reference to FIG. 5, a station 202 may be a wireless mobile station (MS) that also may communicate with one or more base stations (BS) 504 of a wireless communication system 500. The wireless communication system 500 may further include one or more base station controllers (BSC) 506, and a core network 508. The core network may be connected to an Internet 510 and a Public Switched Telephone Network (PSTN) 512 via suitable backhauls. A typical wireless mobile station may include a handheld phone, or a laptop computer. The wireless communication system 500 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

With reference to FIG. 6, the station 202 may include a processor 610, memory (and/or disk drives) 620, secure module 630, display 640, keypad or keyboard 650, microphone 660, speaker(s) 670, camera 680, and the like. Further, the station may also include USB, Ethernet and similar interfaces.

Another aspect of the invention may reside in a station 202, including: means 610 for receiving a first certificate 310 from a server 206 during an initial session, wherein the first certificate has a first certificate chain to an authority certificate 312 signed by a certificate authority 210; means for assigning a signature security rating to each chain certificate in the first certificate chain; means for receiving a second certificate 320 during a subsequent session, wherein the second certificate has a second certificate chain to an authority certificate 322 signed by a certificate authority; means for assigning a signature security rating to each chain certificate in the second certificate chain; means for comparing the signature security rating of each chain certificate in the first certificate chain with the signature security rating of each corresponding chain certificate in the second certificate chain; and means for treating the second certificate as insecure if the signature security rating of a chain certificate 324 in the second certificate chain is lowered from a signature security rating of a corresponding chain certificate 314 in the first certificate chain. The station may include a web client 204.

Another aspect of the invention may reside in a station 202 comprising a processor 610 configured to: receive a first certificate 310 from a server 206 during an initial session, wherein the first certificate has a first certificate chain to an authority certificate 312 signed by a certificate authority 210; assign a signature security rating to each chain certificate in the first certificate chain; receive a second certificate during a subsequent session, wherein the second certificate has a second certificate chain to an authority certificate 322 signed by a certificate authority; assign a signature security rating to each chain certificate in the second certificate chain; compare the signature security rating of each chain certificate in the first certificate chain with the signature security rating of each corresponding chain certificate in the second certificate chain; and treat the second certificate as insecure if the signature security rating of a chain certificate 324 in the second certificate chain is lowered from a signature security rating of a corresponding chain certificate 314 in the first certificate chain.

Yet another aspect of the invention may reside in a computer program product 620 comprising non-transitory computer-readable medium, comprising: code for causing a computer to receive a first certificate 310 from a server 206 during an initial session, wherein the first certificate has a first certificate chain to an authority certificate 312 signed by a certificate authority 210; code for causing a computer to assign a signature security rating to each chain certificate in the first certificate chain; code for causing a computer to receive a second certificate 320 during a subsequent session, wherein the second certificate has a second certificate chain to an authority certificate 322 signed by a certificate authority; code for causing a computer to assign a signature security rating to each chain certificate in the second certificate chain; code for causing a computer to compare the signature security rating of each chain certificate in the first certificate chain with the signature security rating of each corresponding chain certificate in the second certificate chain; and code for causing a computer to treat the second certificate as insecure if the signature security rating of a chain certificate 324 in the second certificate chain is lowered from a signature security rating of a corresponding chain certificate 314 in the first certificate chain.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on as one or more instructions or code on a computer-readable medium. Computer-readable media includes computer storage media that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer-readable medium may be non-transitory such that it does not include a transitory, propagating signal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for protecting against a rogue certificate, comprising:
a client receiving a first certificate from a server during an initial session, wherein the first certificate has a first certificate chain to an authority certificate signed by a certificate authority;
the client assigning a signature security rating to each chain certificate in the first certificate chain;
the client receiving a second certificate during a subsequent session, wherein the second certificate has a second certificate chain to an authority certificate signed by a certificate authority;
the client assigning a signature security rating to each chain certificate in the second certificate chain;
the client comparing the signature security rating of each chain certificate in the first certificate chain with the signature security rating of each corresponding chain certificate in the second certificate chain; and
the client treating the second certificate as insecure if the signature security rating of a chain certificate in the second certificate chain is lowered from a signature security rating of a corresponding chain certificate in the first certificate chain.

2. A method as defined in claim 1, wherein the client provides to a user a warning of an impersonation danger for the second certificate associated with a lowered signature security rating.

3. A method as defined in claim 2, wherein the client provides the warning in the form of a visual display.

4. A method as defined in claim 3, wherein the visual display comprises color coding.

5. A method as defined in claim 1, wherein the client is associated with a web browser application, and the server is associated with a web site.

6. A method as defined in claim 1, wherein the client is associated with a mobile application.

7. A method as defined in claim 1, wherein the client is a remote sensor.

8. A method as defined in claim 1, wherein the client automatically acts on an impersonation danger for the second certificate associated with a lowered signature security rating.

9. A station, comprising:
means for receiving a first certificate from a server during an initial session, wherein the first certificate has a first certificate chain to an authority certificate signed by a certificate authority;
means for assigning a signature security rating to each chain certificate in the first certificate chain;
means for receiving a second certificate during a subsequent session, wherein the second certificate has a second certificate chain to an authority certificate signed by a certificate authority;
means for assigning a signature security rating to each chain certificate in the second certificate chain;
means for comparing the signature security rating of each chain certificate in the first certificate chain with the signature security rating of each corresponding chain certificate in the second certificate chain; and
means for treating the second certificate as insecure if the signature security rating of a chain certificate in the second certificate chain is lowered from a signature security rating of a corresponding chain certificate in the first certificate chain.

10. A station as defined in claim 9, further comprising means for providing to a user a warning of an impersonation danger for the second certificate associated with a lowered signature security rating.

11. A station as defined in claim 10, wherein the warning is provided in the form of a visual display.

12. A station as defined in claim 11, wherein the visual display comprises color coding.

13. A station as defined in claim 9, wherein the server is associated with a web site.

14. A station, comprising:
a processor configured to:
receive a first certificate from a server during an initial session, wherein the first certificate has a first certificate chain to an authority certificate signed by a certificate authority;
assign a signature security rating to each chain certificate in the first certificate chain;
receive a second certificate during a subsequent session, wherein the second certificate has a second certificate chain to an authority certificate signed by a certificate authority;
assign a signature security rating to each chain certificate in the second certificate chain;
compare the signature security rating of each chain certificate in the first certificate chain with the signature security rating of each corresponding chain certificate in the second certificate chain; and
treat the second certificate as insecure if the signature security rating of a chain certificate in the second certificate chain is lowered from a signature security rating of a corresponding chain certificate in the first certificate chain.

15. A station as defined in claim 14, wherein the processor is further configured to warn a user of an impersonation danger for the second certificate associated with a lowered signature security rating.

16. A station as defined in claim 15, wherein the warning is provided in the form of a visual display.

17. A station as defined in claim 16, wherein the visual display comprises color coding.

18. A station as defined in claim 14, wherein the server is associated with a web site.

19. A computer program product, comprising:
computer-readable medium, comprising:
code for causing a computer to receive a first certificate from a server during an initial session, wherein the first certificate has a first certificate chain to an authority certificate signed by a certificate authority;
code for causing a computer to assign a signature security rating to each chain certificate in the first certificate chain;
code for causing a computer to receive a second certificate during a subsequent session, wherein the second certificate has a second certificate chain to an authority certificate signed by a certificate authority;
code for causing a computer to assign a signature security rating to each chain certificate in the second certificate chain
code for causing a computer to compare the signature security rating of each chain certificate in the first certificate chain with the signature security rating of each corresponding chain certificate in the second certificate chain; and
code for causing a computer to treat the second certificate as insecure if the signature security rating of a chain certificate in the second certificate chain is lowered from a signature security rating of a corresponding chain certificate in the first certificate chain.

20. A computer program product as defined in claim 19, further comprising code for causing a computer to warn a user of an impersonation danger for the second certificate associated with a lowered signature security rating.

21. A computer program product as defined in claim 20, wherein the warning is provided in the form of a visual display.

22. A computer program product as defined in claim 21, wherein the visual display comprises color coding.

23. A computer program product as defined in claim 19, wherein the server is associated with a web site.
